(19) United States
(12) Patent Application Publication
(10) Pub. No.: US 2010/0123431 A1
(43) Pub. Date: May 20, 2010

(54) ADAPTER ASSEMBLY FOR RECEIVING CAR CHARGER OF COMMUNICATION DEVICES

(76) Inventors: Tony Prokos, Flushing, NY (US); Catherine S. Prokos, Flushing, NY (US)

Correspondence Address: L.C. BEGIN & ASSOCIATES, PLLC, 510 HIGHLAND AVENUE, PMB 403, MILFORD, MI, 48381, US

(21) Appl. No.: 12/611,625

(22) Filed: Nov. 3, 2009

Related U.S. Application Data
(60) Provisional application No. 61/114,691, filed on Nov. 14, 2008.

(51) Int. Cl. H02J 7/00

(52) U.S. Cl. 320/114; 320/107

(57) ABSTRACT

One embodiment of an adapter assembly for a car charger configured to charge a communication device may include a housing having a floor member. The housing may also have a plurality of supporting members extending from the floor member. The adapter assembly may further include a cover carried by the housing for covering the housing. The cover may have an opening that has a periphery. Further, the adapter assembly may include a receptacle carried within the housing and circumscribingly attached to the periphery of the opening for receiving the car charger. The receptacle may include a base, a body, and an interface member. Furthermore, the adapter assembly may include a direct current voltage converter carried within the housing, and adapted to associate with the interface member of the receptacle and to receive power in the form of alternating current from a power source.

### CROSS REFERENCE TO RELATED APPLICATION

This application claims the benefit of U.S. Provisional Application No. 61/114,691 filed on Nov. 14, 2008 the disclosure of which is incorporated by reference.

### FIELD OF THE DISCLOSURE

The present disclosure generally relates to car chargers electronic devices, and more particularly, to an adapter assembly for receiving any car charger adapted to charge an electronic device.

### BACKGROUND OF THE DISCLOSURE

Individuals, who possess mobile phones and other portable electronic devices, may own car chargers to re-charge the batteries of their devices within their vehicles. These car chargers are typically adapted for charging only one model or a few models of electronic devices, and are transported along with the owners to various destinations throughout a day. The car chargers may not fully re-charge the batteries when, for example, the individual travels generally short distances to places, such as a local restaurant, a coffee shop, a library or a place of employment. Accordingly, the battery may become depleted of its charge thereby rendering the mobile phone at least temporarily inoperable.

### SUMMARY OF THE DISCLOSURE

One embodiment of an adapter assembly for a car charger configured to charge a communication device may include a housing having a floor member and a plurality of supporting members extending from a peripheral portion of the floor member. Further, the adapter assembly may include a cover carried by the housing for covering the housing. The cover may have an opening including a periphery.

Furthermore, the adapter assembly may include a receptacle carried within the housing and circumscribingly attached to the periphery of the opening, for receiving the car charger. The receptacle may include a base having a first member and a second member carried transversely by the first member. The base may be configured with a groove thereon. Further, the receptacle may include a body circumscribingly attached to the base and extending from the base. The receptacle may also include an interface member associated with the groove of the base and extending from the first member within the housing. The body may be adapted to detachably receive a connecting member of the car charger and the groove may be adapted to detachably receive a protruding member extending outwardly from the connecting member of the car charger.

Moreover, the adapter assembly may include a Direct Current (DC) voltage converter carried within the housing, and adapted to associate with the interface member of the receptacle. The DC voltage converter may further be adapted to receive power in the form of alternating current from a power source through an electrical means. In addition, the DC voltage converter may be adapted to convert the alternating current to direct current. The direct current may be supplied to the car charger through the interface member and the groove of the receptacle for charging the communication device.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of one embodiment of an adapter assembly for receiving a car charger of a communication device;

FIG. 2 is a cross-sectional view of the adapter assembly of FIG. 1 along the plane X-Y;

FIG. 3 is a top view of the adapter assembly of FIG. 1;

FIG. 4 is an unassembled perspective view of a base of a receptacle of the adapter assembly of FIG. 1; and

FIG. 5 is a perspective view of the adapter assembly of FIG. 1 engaged with the car charger and plugged-in an electrical wall outlet.

Like reference numerals refer to like parts throughout the description of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular lighting system, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Further, the term “first,” “second,” and the like, herein do not denote any order, elevation or importance, but rather are used to distinguish placement of one element over another. Further, the terms, “a” and “an” herein do not denote a limitation of quantity, but rather denote the presence of at least one of the referenced item. Unless limited otherwise, the term “associated,” “coupled” and variations thereof herein are used broadly and encompass direct and indirect associations and couplings.

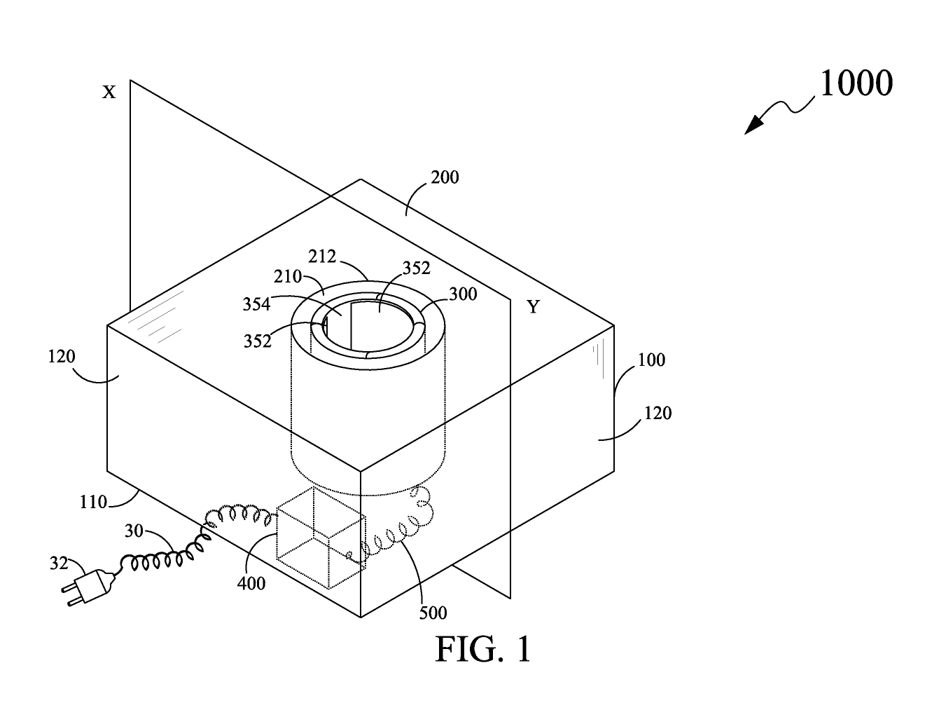

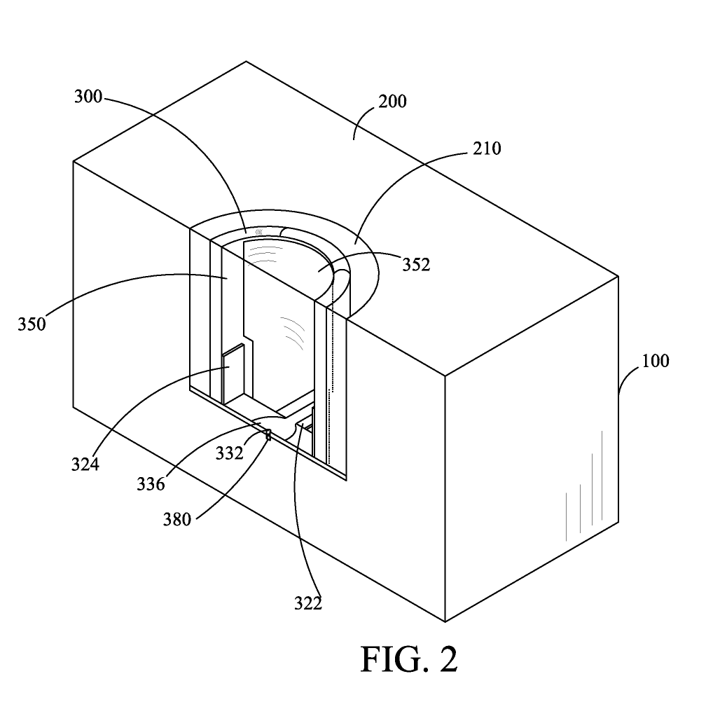

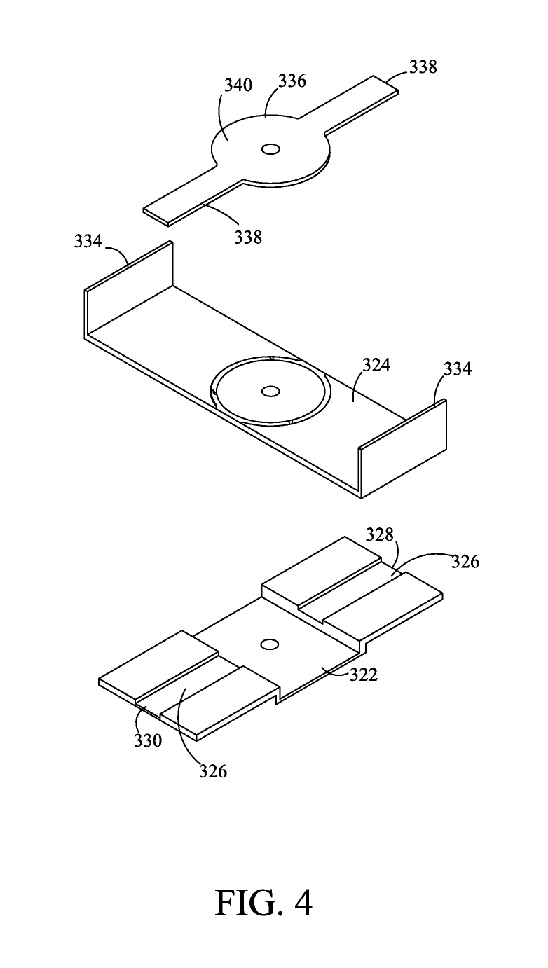

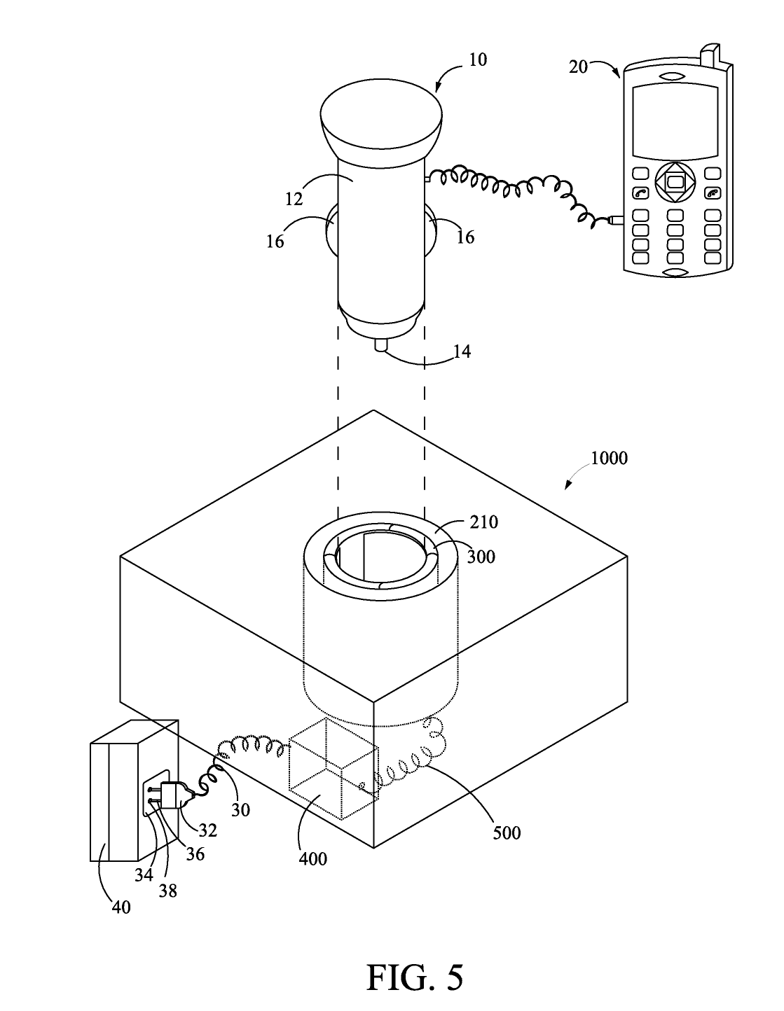

Referring to FIGS. 1-5, one embodiment of an adapter assembly 1000 for a car charger 10 may be used to re-charge a battery of a communication device 20, such as a cellular phone. Of course, the car charger may be used for charging any electronic device.

The adapter assembly 1000 may include a housing 100 having a floor member 110 that may include a peripheral portion. The housing may further have a plurality of supporting members 120 extending from the peripheral portion of the floor member 110. The housing 100 may optionally include a clamp that may be allowed to engage with a nail on a wall for mounting the adapter assembly 1000 on the wall. The housing 100 may be manufactured from a material, such as a wooden material, a plastic material, and the like. Of course, the housing 100 may be manufactured from any other material without departing from the scope of the present disclosure. Further, the housing 100 may be in the form of a modular box having a cubical shape. Of course, the housing 100 may instead be configured to have any other shape and/or size as per a manufacturer's preference.

Further, the adapter assembly 1000 may include a cover 200 carried by the housing 100 for covering the housing 100. The cover 200 may have an opening 210 including a periphery 212. Further, the cover 200 may snugly fit onto the housing 100. Of course, the cover 200 may be carried by the housing 100 by any other means of attachment, such as nut and bolts.

The cover 200 may be manufactured from any suitable material, such as wood, plastic, and the like. Further, the cover 200 may be designed to have a shape and a size complementary to that of the housing 100. Furthermore, the cover 200 may be designed to match or complement any décor. Accordingly, the cover 200 may be configured to have any color as per a manufacturer's preference.

The adapter assembly 1000 may further include a receptacle 300 carried within the housing 100 and circumscribingly attached to the periphery 212 of the opening 210. In one form, the receptacle 300 may be soldered to the periphery 212 of the opening 210. Alternately, the receptacle 300 may be attached to the periphery 212 by other fasteners, such as adhesives, nut and bolts, and the like.

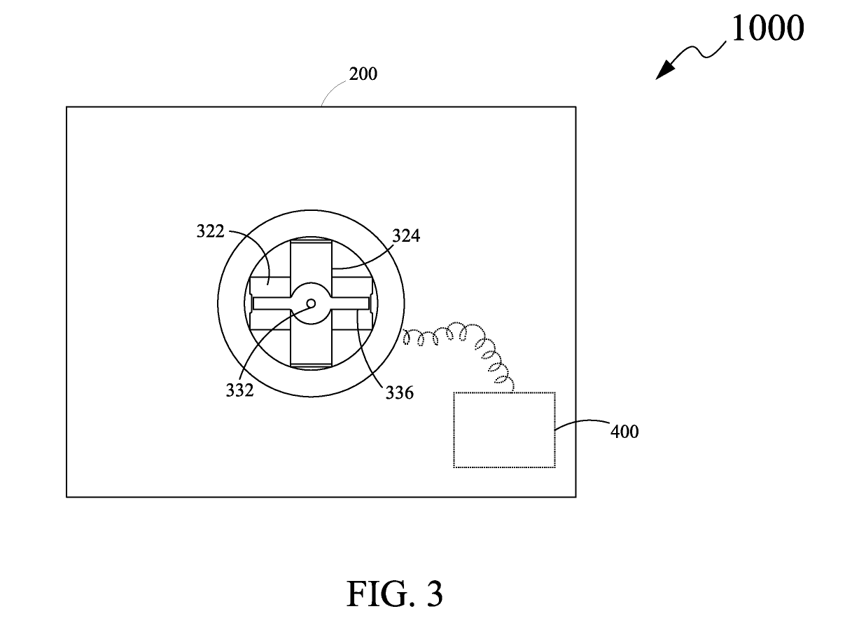

As best shown in FIG. 3, the receptacle 300 may be configured for receiving the car charger 10. The receptacle 300 may include a base 320 that may be a three-piece component. The base 320 may have a first member 322 and a second member 324 carried transversely by the first member 322. Further, the base 320 may include a third member 336 transversely carried by the second member 324. The base 320 may also include a groove 332 configured thereon. Specifically, each of the first, second and third members 322, 324 and 336 may have openings at respective center portions thereof, which align to form the groove 332 of the base 320.

Each of the first member 322 and the second member 324 may be in the form of strips. Of course, the first member 322 and the second member 324 may have any other suitable shape. The first member 322 of the base 320 may include one or more slots 326. For example, the first member 322 of the base 320 may include two slots 326 formed in a respective one of end portions 328, 330 of the first member 322. The second member 324 may include one or more flanges 334.

The third member 336 may be in the form of a ring with a plurality of protrusions 338 extending away from a center portion 340 of the third member 336. One of the protrusions 338 may be received within one of the slots 326 of the first member 322. Of course, the third member 336 may have any other suitable shape. In one form, the first member 322, the second member 324, and the third member 336 may be manufactured as a single unit structure.

Further, the receptacle 300 may include a body 350 circumscribingly attached to the base 320 and extending from the base 320. The body 350 may include a plurality of ridge members 352 extending from the base 320 within the body 350. The ridge members 352 may be circumscribingly arranged in a spaced apart relation about the groove 332 in order to form a plurality of channels 354 between respective ridge members 352. In one form, the receptacle 300 may include two ridge members 352 forming two channels 354 therebetween, when the ridge members 352 are circumscribingly arranged in the spaced apart relation about the groove 332.

The receptacle 300 may also include an interface member 380 associated with the groove 332 and extending from the first member 322 within the housing 100. The interface member 380 may be electrically coupled to the groove 332.

The receptacle 300 may be made of a conductive material, such as steel, brass, and the like. Of course, the receptacle 300 may be made of any other conductive material. Further, the receptacle 300 may have a shape and a size complementary to the shape and size of the car charger 10.

The car charger 10 may include a connecting member 12 detachably received within the receptacle 300. Specifically, the connecting member 12 may be detachably received within the body 350 of the receptacle 300. The car charger 10 may further include a protruding member 14 extending outwardly from the connecting member 12 and adapted to be detachably received within the groove 332 of the receptacle 300. The car charger 10 may snugly fit within the receptacle 300 with the help of the protruding member 14 being received and fitted within the groove 332 of the receptacle 300. The car charger 10 may further include a plurality of extension members 16 configured on the connecting member 12. In one form, the car charger 10 may include two extension members 16. The extension members 16 may be adapted to be slidably received within the channels 354 between respective ridge members 352.

The adapter assembly 1000 may also include a Direct Current (DC) voltage converter 400 carried within the housing 100. The DC voltage converter 400 may include a current input unit adapted to receive power in the form of 120 Volts (V) of Alternating Current (AC) from an electrical power source through an electrical means 30. Specifically, the electrical means 30 may be a wire having a male connector 32, such as a two or three pronged plug, adapted to be received by a female connector 34 configured within an electrical wall outlet 40. The male connector 32 may instead have pins 36 adapted to be received within slots 38 of the female connector 34. The AC current provided to the current input unit may hereinafter interchangeably be referred to as input current.

The DC voltage converter 400 may be adapted to convert the AC current to DC current, i.e., charge, and to send the charge to the interface member 380 of the receptacle 300. Accordingly, the DC voltage converter 400 may be associated with the interface member 380 of the receptacle 300 in order to supply the charge to the car charger 10 for charging the communication device 20. Specifically, the DC voltage converter 400 may be electrically coupled to the interface member 380 through a wire 500.

The DC voltage converter 400 may further include other electrical components for operating the adapter assembly 1000, without departing from the scope of the present disclosure. For example, the DC voltage converter 400 may additionally include a power/signal jack, and/or a voltage regulator adapted to automatically regulate the voltage of the AC current and to drive the DC voltage converter 400 to output a predetermined DC current that needs to be provided to the car charger 10 for charging the communication device 20.

In use, the car charger 10 associated with the communication device 20 may be allowed to be received within the receptacle 300 of the adapter assembly 1000. The adapter assembly 1000 may then be plugged-in the electrical wall outlet 40 through the electrical means 30. The electrical power source may then supply AC current to the DC voltage converter 400 of the adapter assembly 1000 via the electrical means 30. Subsequently, the AC current, i.e., the input current may then be converted to the DC current, i.e., the charge. The charge may then be transmitted by the DC voltage converter 400 to the groove 332 through the interface member 380 of the receptacle 300 via the wire 500. The protruding member 14 of the car charger 10 that is received within the groove 332 may receive the charge from the groove 332. Therefore, receiving of the car charger 10 and components thereof, such as the protruding member 14, within the receptacle 300 enables the establishment of the electrical coupling between the car charger 10 and the DC voltage converter 400. The car charger 10 may then charge a battery of the communication device 20.

For the purpose of the description, the adapter assembly 1000 is shown and described as being used for charging the cellular phone 20. Of course, the adapter assembly 1000 may be utilized for charging other communication devices, such as a Personal Digital Assistant (PDA), a Global Positioning System (GPS), and the like. Further, as shown and described the adapter assembly 1000 may include only one receptacle 300. However, it should be evident that the adapter assembly 1000 may have more than one receptacle 300.

The present disclosure provides an adapter assembly, such as the adapter assembly 1000, for a car charger of a communication device. The adapter assembly may be installed at any location including public places, such as a restaurant and the like, for delivering charge to a communication device at any location. Further, the adapter assembly may be mounted on a wall. The adapter assembly serves as a tool for users who need to charge communication devices with low or dead battery, at any point of time. Specifically, the adapter assembly may be used for charging communication devices when a user may be dining out or may be at any public place. The user may simply need to get a car charger, such as a car charger available in a vehicle, for example a car, and to plug-in the car charger into the adapter assembly while associating the car charger to his/her communication device. The adapter assembly may also assist a household equipped with several communication devices of different makes and models. Accordingly, the adapter assembly may serve as a universal port for all types of communication devices.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An adapter assembly for a car charger configured to associate with a communication device for charging the communication device, the adapter assembly comprising:
a housing including a floor member having a peripheral portion, and the housing further having a plurality of supporting members extending from the peripheral portion;
a cover carried by the housing for covering the housing, the cover including an opening that has a periphery;
a receptacle carried within the housing and circumscribingly attached to the periphery of the opening for receiving the car charger, the receptacle comprising,
a base having a first member and a second member carried transversely by the first member, the base having a groove,
a body circumscribingly attached to the base and extending from the base, and
an interface member associated with the groove of the base and extending from the first member within the housing,
wherein the body is adapted to detachably receive a connecting member of the car charger and the groove is adapted to detachably receive a protruding member extending from the connecting member of the car charger; and
a direct current voltage converter carried within the housing, and adapted to associate with the interface member of the receptacle, the direct current voltage converter further adapted to receive power in the form of alternating current from a power source through an electrical means and to convert the alternating current to direct current, wherein the direct current is supplied to the car charger through the interface member and the groove of the receptacle for charging the communication device.

2. The adapter assembly of claim 1, wherein the connecting member includes a plurality of extension members.

3. The adapter assembly of claim 2, wherein the body further comprises a plurality of ridge members extending from the base, the plurality of ridge members being circumscribingly arranged in a spaced apart relation within the body for forming a plurality of channels between respective ridge members, one of the plurality of channels being adapted to slidably receive one of the plurality of extension members of the car charger.

4. The adapter assembly of claim 1, wherein the first member of the base comprises at least one slot formed in an end portion of the first member, and wherein the second member comprises at least one flange.

5. The adapter assembly of claim 4, wherein the base further comprises a third member transversely carried by the second member, the third member comprising a plurality of protrusions received within the at least one slot of the first member.

6. The adapter assembly of claim 1, wherein the communication device is a cellular phone.
